(19) United States
(12) Patent Application Publication
(10) Pub. No.: US 2002/0134388 A1
(43) Pub. Date: Sep. 26, 2002

(54) Anaesthetic medical facemask

(76) Inventor: Ti-Li Chang, Taichung Hsien (TW)

Correspondence Address: Cooper & Dunham LLP, 1185 Avenue of the Americas, New York, NY, 10036, US

(21) Appl. No.: 09/813,968

(22) Filed: Mar. 21, 2001

(51) Int. Cl. A62B 18/02

(52) U.S. Cl. 128/206.21

(57) ABSTRACT

An anaesthetic medical facemask includes a disposable air cushion and a reusable shell attached to the air cushion. The air cushion is made of thermoplastic urethane elastomer (TPU). TPU is a hydrolysis material so that the TPU can decompose in a short time. The air cushion is thrown away and does not pollute the environment after use. The shell can be with another patient after disinfecting the shell because the shell never comes in direct contact with the patient during use. Consequently, the volume of the medical waste is smaller and the cost of environmental protection becomes lower.

### BACKGROUND OF THE INVENTION

1. Field of the Invention

The present invention relates to a medical facemask, and more particularly to an anaesthetic medical facemask that includes a throwaway air cushion to prevent the patient from being infected and an autoclavable shell autoclaved after each use to reduce the volume of garbage. The present invention looks after both sides of public heath and environment protection.

2. Description of Related Art

A conventional anaesthetic medical facemask in accordance with the prior art is used with another patient after disinfecting. The next patient may be infected when the anaesthetic medical facemask is not fully disinfected. Consequently, disposable anaesthetic medical facemasks are marketed. Disposable anaesthetic medical facemasks can effectively prevent the patient from being infected. However, the costs of equipment and to the environment are very high. The volume of garbage is large because the entire anaesthetic medical facemask is discarded. Furthermore, the health authority has to accommodate high costs in the correct disposal of medical waste, and if that waste has an unnecessarily high volume due to so many used anaesthetic medical facemasks, then the costs will be accordingly higher. The conventional anaesthetic medical facemask needs to be advantageously altered.

The present invention has arisen to mitigate and/or obviate the disadvantages of the conventional anaesthetic medical facemask.

### SUMMARY OF THE INVENTION

The main objective of the present invention is to provide an improved anaesthetic medical facemask. The anaesthetic medical facemask in accordance with the present invention includes a shell and an air cushion attached to the shell. The air cushion is thrown away after use because the air cushion is in contact with the patient. The shell is autoclaved after each use because it does not come in contact with the patient. Consequently, the shell can be used with another patient after disinfecting the shell, thereby to reducing the volume of medical garbage.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an anaesthetic medical facemask in accordance with the present invention;

FIG. 2 is an exploded perspective view of the anaesthetic medical facemask in FIG. 1; and

FIG. 3 is an enlarged cross sectional partial side plan view of the anaesthetic medical facemask in FIG. 1 showing how the shell attaches to the air cushion.

### DETAILED DESCRIPTION OF THE INVENTION

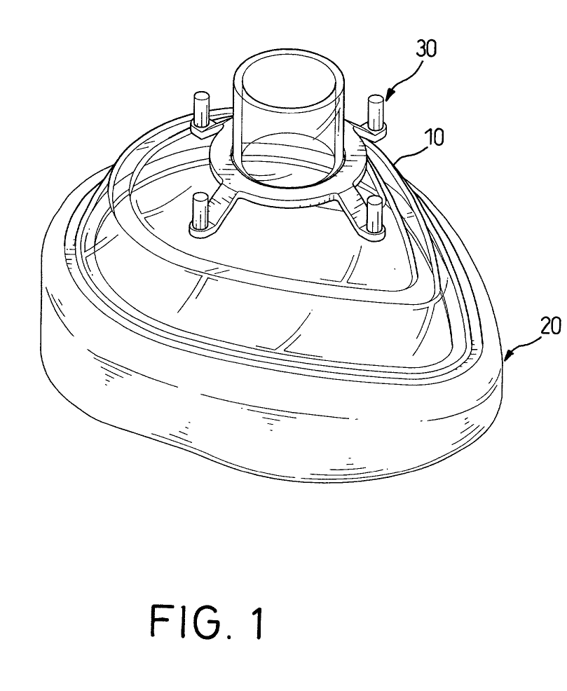

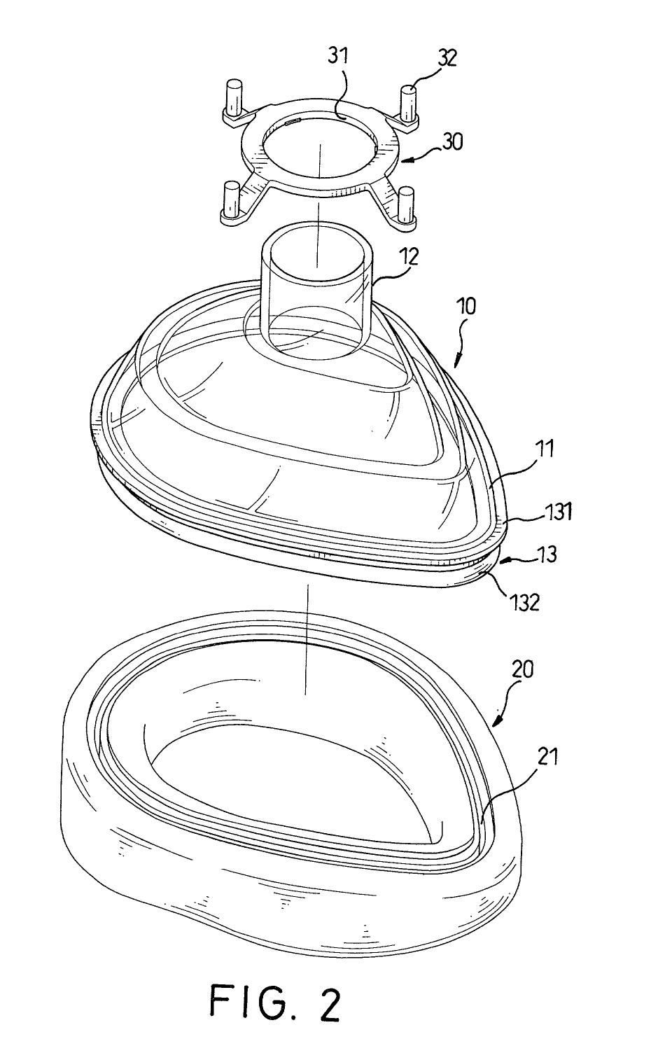

With reference to the drawings and initially to FIGS. 1 and 2, an anaesthetic medical facemask in accordance with the present invention comprises a throwaway air cushion (20) and a recyclable shell (10) attached to the air cushion (20). The air cushion (20) is made of thermoplastic urethane elastomer (TPU). TPU is a hydrolysis material so that the TPU can decompose in a short time. Consequently, the air cushion (20) is thrown away and does not pollute the environment after use. The shell (10) can be used with another patient after disinfecting the shell (10) because the shell (10) never comes in direct contact with the patient during use.

The shell (10) is transparent and is formed similar to a frustum corresponding to a mouth and a nose of a human. A frame (11) is formed on the bottom of the shell (10) and corresponds to the shape of the shell (10). A hollow connector (12) is formed on the top of the shell (10) and communicates with the interior of the shell (10). The connector (12) is adapted to be connected to an anaesthetic source or an oxygen source. A hook ring (30) is mounted on the shell (10) and has a through hole (31) defined to receive the connector (12). Multiple studs (32) axially extend from the periphery of the hook ring (30) relative to the connector (12). The studs (32) are adapted to be connected with an elastic strap (not shown) to hold the anaesthetic medical facemask in place on a human's face.

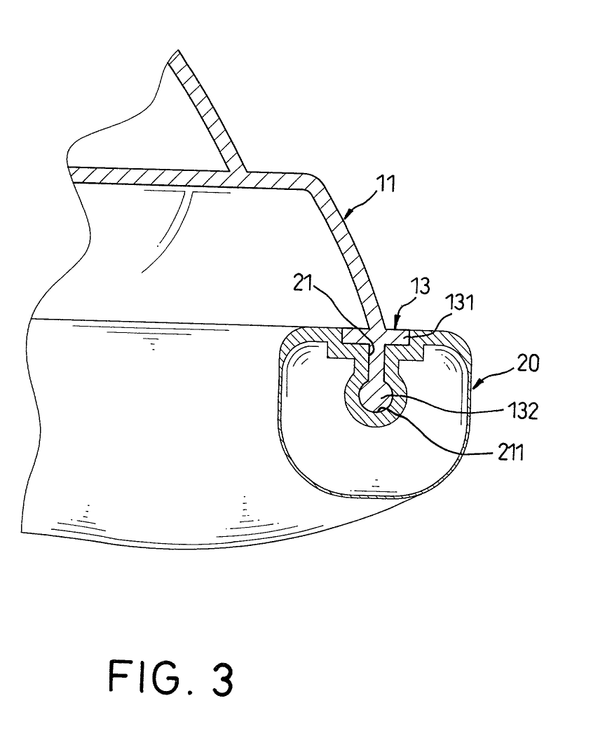

With reference to FIG. 3, a cushion connector (13) extends downward from the frame (11) of the shell (10). The cushion connector (13) has a transverse flange (131) formed at the edge of the shell (10) and a rib with an enlarged outer edge (132) projecting perpendicular from the transverse flange (131) to which the air cushion (20) is connected.

The air cushion (20) has a shape corresponding to the cushion connector (13) on the shell (10). The air cushion (20) includes a first side having a resilient groove (21) defined to securely receive the cushion connector (13). A recess (211) is defined in the air cushion (20) and communicates with the groove (21). The recess (211) is wider than the groove (21). To assemble the shell (10) and the air cushion (20), the cushion connector (13) is inserted into the groove (21) and the outer edge (132) is received in the recess (211) of the groove (21).

The shell (10) is autoclavable so that the shell (10) can be used with a subsequent patient after disinfecting the shell (10) because the shell (10) never comes in direct contact with the patient. The air cushion (20) is disposable so the volume of the garbage is smaller and the cost of environmental protection becomes lower.

Although the invention has been explained in relation to its preferred embodiment, it is to be understood that many other possible modifications and variations can be made without departing from the spirit and scope of the invention as hereinafter claimed.

What is claimed is:

1. An anaesthetic medical facemask comprising:
a shell including:
a frame formed on a bottom of the shell and corresponding to the shape of the shell;
a hollow connector formed on a top of the shell, the connector having a through hole defined to extend through the shell and adapted to be connected to a gas source; and
a cushion connector extending downward from the frame of the shell, the cushion connector having a transverse flange formed near the edge of the shell and an enlarged outer edge projecting perpendicular from the transverse flange; and
an air cushion attached to the shell, the air cushion including one side having a groove defined to securely receive the cushion connector and a recess defined to communicate with the groove, the recess being wider than the groove and receiving the outer edge of the cushion connector.

2. The anaesthetic medical facemask as claimed in claim 1, wherein the air cushion is made of hydrolysis material.
